(19) United States
(12) Patent Application Publication
(10) Pub. No.: US 2026/0360629 A1
(43) Pub. Date: Nov. 12, 2026

(54) CAPACITOR ELEMENT AND ELECTROLYTIC CAPACITOR

(71) Applicant: Panasonic Intellectual Property Management Co., Ltd., Osaka (JP)

(72) Inventors: Masami TSUBAKI, KYOTO FU (JP); Mitsuhisa YOSHIMURA, OSAKA FU (JP); Toshifumi KADOKAWA, HYOGO KEN (JP)

(21) Appl. No.: 19/739,202

(22) Filed: Jul. 13, 2026

Related U.S. Application Data
(63) Continuation of application No. PCT/JP2025/002282, filed on Jan. 24, 2025.

(30) Foreign Application Priority Data
Jan. 29, 2024 (JP) 2024-011349

(51) Int. Cl. H01G 9/055; H01G 9/15

(52) U.S. Cl. CPC H01G 9/055; H01G 9/15

(57) ABSTRACT

A capacitor element includes a metal foil containing a valve metal, and having two principal surfaces. The metal foil has a first portion which is a cathode forming part, a second portion including an anode lead-out part, and a separation portion between the first portion and the second portion. The first portion, the separation portion, and the second portion each have porous parts having the principal surfaces, and a core part continuous with the porous parts. The metal foil has an uneven region having a plurality of recesses, on the principal surfaces, and at least part of the separation portion overlaps with the uneven region.

### CROSS REFERENCE TO RELATED APPLICATION

The present application is a continuation application of International Application No. PCT/JP2025/002282, filed on Jan. 24, 2025 and claims priority with respect to the Japanese Patent Application No. 2024-011349 filed on Jan. 29, 2024. The entire contents of these applications are incorporated herein by reference.

### TECHNICAL FIELD

The present disclosure relates to a capacitor element and an electrolytic capacitor.

### BACKGROUND

Patent Literature 1 (WO2006/137482) discloses a “base material for a solid electrolytic capacitor having a porous layer at a surface thereof, wherein at least part of the porous layer between an anode region and a cathode region is reduced”.

Patent Literature 2 (JP2023-015261A) discloses an “electrode foil before incorporated into a wound capacitor, the electrode foil formed from a belt-like foil and including: an enlarged surface portion that is formed on a surface of the foil and includes a large number of tunnel-shaped pits; a core portion which is a rest of the foil excluding the enlarged surface portion; a plurality of dividing portions that divide the enlarged surface portion; and a dielectric film formed on the surface of the enlarged surface portion or on the surfaces of the dividing portions, wherein, when incorporated into the wound capacitor, the electrode foil is wound while the dividing portions are present”.

Patent Literature 3 (JP2022-099215A) discloses an “electrode foil for an electrolytic capacitor, the electrode foil being an electrode foil extending in a longitudinal direction and having a width direction orthogonal to the longitudinal direction, wherein the electrode foil has an enlarged surface portion at a surface of the electrode foil, and a crack is formed in the enlarged surface portion in a direction oblique to the width direction”.

Patent Literature 4 (JP4547835B) discloses a “solid electrolytic capacitor, comprising: a capacitor element that includes an anode body being formed from a valve metal provided with a roughened layer formed by roughening a surface of the anode body, a cathode section having a dielectric oxide film layer, a solid electrolyte layer, and a conductor layer formed sequentially on a part of an outer surface of the anode body, and an anode lead-out part provided on a rest of the outer surface of the anode body; lead terminals connected respectively to the cathode section and the anode lead-out part of the capacitor element; and a packaging resin covering the capacitor element, with the lead terminals each partially exposed externally, wherein a first band gap for separating the anode body into the anode lead-out part and the cathode section, and a second band gap having a surface area smaller than the first band gap are provided, the first band gap is an compressed layer or a melt-condensed layer formed by being processed so as to have a small surface area relative to a surface area of the roughened layer of the valve metal, and an electrically insulating member is provided so as to cover the surfaces of the first and second band gaps”.

### SUMMARY

Various processes are applied to an electrode foil for capacitor elements of electrolytic capacitors. Such processes may include slitting, crimping, punching, and welding of the electrode foil. In these processes, the electrode foil is subjected to stresses, such as bending stress, tensile stress, and heat stress.

When, for example, part of the porous part is reduced as in Patent Literature 1, or dividing portions are formed in the foil as in Patent Literature 2, this reduces the tensile strength and makes it difficult to distribute the stress, thereby causing a failure, such as the occurrence of cracking.

One aspect of the present disclosure relates to a capacitor element, including: a metal foil containing a valve metal, and having two principal surfaces, wherein the metal foil has a first portion which is a cathode forming part, a second portion including an anode lead-out part, and a separation portion between the first portion and the second portion, the first portion, the separation portion, and the second portion each have porous parts having the principal surfaces, and a core part continuous with the porous parts, the metal foil has an uneven region having a plurality of recesses, on the principal surfaces, and at least part of the separation portion overlaps with the uneven region.

Another aspect of the present disclosure relates to an electrolytic capacitor, including: the above-described capacitor element in which at least the porous parts of the first portion have a dielectric layer; and a cathode section covering at least part of the dielectric layer, wherein the cathode section contains a conductive polymer.

According to the present disclosure, in a capacitor element that has a first portion serving as a cathode forming part, a second portion including an anode lead-out part, and a separation portion between the first and second portions, the strength of the separation portion can be improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic sectional view of a capacitor element according to one embodiment of the present disclosure.

FIG. 2 is a partial schematic plan view of the capacitor element of FIG. 1.

FIG. 3 is a detailed schematic sectional view of the capacitor element of FIG. 1.

FIG. 4 is a partial schematic plan view of another capacitor element.

FIG. 5 is a partial schematic plan view of yet another capacitor element.

FIG. 6 is a partial schematic plan view of still another capacitor element.

FIG. 7 is a partial schematic plan view of still another capacitor element.

FIG. 8 is a schematic sectional view of an electrolytic capacitor according to one embodiment of the present disclosure.

FIG. 9 is a top-view SEM image of an example of an uneven region.

FIG. 10 is a sectional-view SEM image of an example of the uneven region.

### DETAILED DESCRIPTION

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” means to include the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

In the present disclosure, the electrolytic capacitor may be of any type. The present disclosure is applicable to all electrolytic capacitors that include a metal foil having: a first portion as a cathode forming part; a second portion including an anode lead-out part; and a separation portion between the first portion and the second portion. The electrolytic capacitor may be a solid electrolytic capacitor, a solid-liquid hybrid electrolytic capacitor, and the like. In any electrolytic capacitor, the strength of the separation portion is improved, and the phenomena that occur due to foil breakage and cracking in the separation portion can be suppressed. In particular, in a solid electrolytic capacitor having a conductive polymer as a solid electrolyte, the strength of the separation portion can be remarkably improved by using the capacitor element according to the present disclosure.

### (Capacitor Element)

A capacitor element according to one embodiment of the present disclosure includes a metal foil containing a valve metal and having two principal surfaces. The metal foil has a first portion serving as a cathode forming part, a second portion including an anode lead-out part, and a separation portion between the first portion and the second portion. The material of the electrode foil can be a valve metal, such as aluminum, tantalum, niobium, and titanium.

The first portion, the separation portion, and the second portion each have porous parts which respectively have the above principal surfaces, and a core part continuous with the porous parts. That is, the principal surfaces are principal surfaces of the porous parts, and the metal foil is an electrode foil or an etched foil.

The separation portion is a region that provides electrical insulation between the cathode section formed in the first portion and the anode lead-out part in the second portion. At least part of the porous parts in the separation portion may be impregnated with an electrically insulating resin (e.g., resist resin). On the surfaces of the porous parts in the separation portion, an electrically insulating tape may be attached.

Here, the metal foil has an “uneven region” (concave-convex region) having a plurality of recesses formed on the principal surfaces thereof. At least part of the separation portion overlaps with the uneven region. At least part of the first portion may overlap with the uneven region. At least part of the second portion may overlap with the uneven region. That is, at least the principal surfaces of (the porous parts of) the separation portion have an “uneven region” having a plurality of recesses. The uneven region may also be formed on at least part of the principal surfaces of the first portion. The uneven region may also be formed on at least part of the principal surfaces of the second portion. The uneven region that the first portion or the second portion has may be continuous with the uneven region that the separation portion has.

When viewed from the direction normal to the principal surface of the metal foil (electrode foil), the projected area corresponding to 70% or more of the projected area of the separation portion may be a projected area of the uneven region, or the entire separation portion may be the uneven region. The uneven region may be formed on only one principal surface of the separation portion or on both principal surfaces thereof.

When viewed from the direction normal to the principal surface of the metal foil (electrode foil), at least 70% of the projected area of the first portion may be a projected area of the uneven region, or the entire first portion may be the uneven region.

When viewed from the direction normal to the principal surface of the metal foil (electrode foil), at least 70% of the projected area of the second portion may be a projected area of the uneven region, or the entire second portion may be the uneven region.

In the uneven region, by controlling the parameters, such as the shape, the depth, and the spacing of the plurality of recesses, the stress during process is highly distributed, and especially the folding endurance is remarkably improved. The separation portion may be subjected to compression, embossing, imprint, and other processing. In such a case, the tensile strength can be further improved because the voids decrease.

By providing an uneven region in the separation portion, the cracking and the foil breakage that reach as far as the first portion or the second portion can be suppressed in various processes.

When a plurality of recesses are arranged in a regular pattern, stress is especially well-distributed, and the strength of the separation portion is remarkably improved. Furthermore, the foil breakage and the cracking can be suppressed in the processes of cutting (slitting), foil transport, stacking, punching, welding, crimping, winding, and the like.

The width of the uneven region (hereinafter may be referred to as the “width W3”) in the direction from the first portion toward the second portion (hereinafter may be referred to as the “direction D12”) may be 10% or more of the length of the first portion in the direction D12 (hereinafter may be referred to as the “length L1”), and may be 15% to 80%. When the ratio of the width W3 of the uneven region to the length L1 of the first portion is within the above range, the foil breakage and the cracking in the separation portion can be remarkably suppressed. The width W3 of the uneven region may match the width of the separation portion in the direction D12 or may be smaller than the width of the separation portion. It is preferable however that the width W3 of the uneven region is equal to or larger than the width of the separation portion. When the width W3 of the uneven region is larger than the width of the separation portion, the uneven region can be a region that reaches at least one of the first and second portions adjacent to the separation portion.

In the separation portion and other portions, the uneven region may satisfy at least one of the following conditions (A) and (B):
(A) the depth H of the recesses is 5% or more and 80% or less (preferably 20% or more and 40% or less) of the distance from a surface of a non-recessed portion where no recess is formed, to the core part.
(B) the projected area ratio Ras of the recesses in the uneven region is 3% or more and 65% or less (preferably 10% or more and 50% or less).

The condition (A) may be satisfied on only one of the principal surfaces of the separation portion, and may be satisfied on both principal surfaces thereof. The condition (A) is preferably satisfied on both principal surfaces of the separation portion. The condition (B) may be satisfied on only one of the principal surfaces of the separation portion, and may be satisfied on both principal surfaces thereof. The condition (B) is preferably satisfied on both principal surfaces of the separation portion.

When the uneven region is provided on both principal surfaces of the separation portion, in both principal surfaces, the depth H of the recesses and the projected area ratio of the recesses in the principal surface region may be the same or different. When the separation portion is viewed from the direction normal to the principal surface thereof, the recesses constituting the uneven region on one principal surface and the recesses constituting the uneven region on the other principal surface may overlap, but preferably, do not overlap with each other.

When the first portion has an uneven region, the uneven region that the separation portion has and the uneven region that the first portion has may be in forms different from each other. In the uneven region that the separation portion has and the uneven region that the first portion has, for example, the shape, the arrangement, the size, and the depth of the recesses, and the projected area ratio of the recesses may be the same or different.

When the second portion has an uneven region, the uneven region that the separation portion has and the uneven region that the second portion has may be in forms different from each other. In the uneven region that the separation portion has and the uneven region that the second portion has, for example, the shape, the arrangement, the size, and the depth H of the recesses, and the projected area ratio Ras of the recesses may be the same or different.

The depth H of the recesses in the condition (A) can be measured in a cross section (hereinafter may be simply referred to as a “foil cross-section”) parallel to the thickness direction of the metal foil (electrode foil) or the separation portion (hereinafter may be simply referred to as the “foil”). The foil cross-section, which is formed such that the deepest points of at least two recesses closest to each other can be observed, is observed using a scanning electron microscope (SEM). The average value of the two distances (the distances in the direction parallel to the thickness direction of the foil) measured from the highest point of the non-recessed portion between the recesses closest to each other to the deepest points of the recesses closest to each other across the non-recessed area is a depth H of the recesses. The depth H of the recesses is measured at least at five spots on the foil, and determined as an average of the measured values. When the recesses are recesses extending in a line shape, the “foil cross-section” is a cross section which is in parallel with the thickness direction and intersects with the extending direction of the line-shaped recesses, at an angle of 80° to 100° (e.g., 90°).

The “projected area ratio of the recesses in the uneven region” in the condition (B) refers to a ratio of the total of the projected areas of the plurality of recesses onto the principal surface region, relative to the projected area of the uneven region as viewed from the direction normal to the uneven region (hereinafter may be referred to as the “recess projected area ratio Ras”). The projected area of the uneven region for measuring the recess projected area ratio Ras is set to, for example, 1 mm² or more. When the uneven region is observed with a SEM from the direction normal to that uneven region, the recesses and the non-recessed portions can be distinguished by their color tone. The recesses and the non-recessed portions may be distinguished by binarizing the SEM image based on the common technical knowledge.

The ratio H/F of the depth H (μm) of the recesses to the thickness F (μm) of the separation portion is preferably 0.03 or more and 0.45 or less, more preferably 0.05 or more and 0.3 or less, and even more preferably 0.1 or more and 0.25 or less. When the H/F is within the above range, the folding endurance of the separation portion can be easily ensured. The thickness F (μm) of the separation portion is measured at least at five points on the non-recessed portions, and determined as an average of the measured values. The thickness F (μm) of the separation portion may also be measured, at any five points, as a value twice the distance from the center of the core part to the surface of the non-recessed portion in the porous part.

The ratio H/T of the depth H of the recesses to the thickness T of the porous part is preferably 0.15 or more and 0.75 or less, and more preferably 0.20 or more and 0.40 or less. When the H/T is within the above range, the folding endurance of the separation portion can be easily ensured.

A description will be given below of the case where the uneven region has a plurality of recesses scattered in an island shape.

When viewed from the direction normal to the uneven region, the shape of each of the recesses (the shape of the opening of the recess) constituting the plurality of recesses is not particularly limited.

In the following, some of the parameters that define the plurality of recesses scattered in an island shape will be described. The recesses satisfying any of the following conditions are particularly effective in enhancing the folding endurance and the tensile strength of the separation portion.

A number density Nd of the recesses in the uneven region may be 4 recesses/mm² or more, and 1200 recesses/mm² or less. The number density Nd may be 10 recesses/mm² or more, and 300 recesses/mm² or less. The area of the uneven region for measuring the number density Nd may be, for example, 1 mm² or more. Note that the “number density” refers to the number of the recesses formed per unit area of the uneven region. When the uneven region is provided on both principal surfaces of the foil, the number density Nd of the recesses in both uneven regions may be the same or different.

The projected area Sn per recess of the recesses (when viewed from the direction normal to an uneven region, the area of the recess projected onto the uneven region) may be 150 μm² or more and 13,000 μm² or less. The projected area Sn per recess may be 500 μm² or more and 7000 μm² or less. The projected area Sn per recess is determined as an average value of the projected areas Sn of at least five randomly selected recesses. When the uneven region is provided on both principal surfaces of the foil, the projected area Sn per recess in the both uneven regions may be the same or different.

The ratio of a long side Lmax to a short side Lmin of the smallest rectangle surrounding each of the recesses (hereinafter may be referred to as an “aspect ratio”) may be 1.0 to 2.5. Such recesses exhibit low anisotropy. Therefore, the tensile strength of the separation portion or the foil is less dependent on the direction of tension, making it easy to ensure the isotropy of the tensile strength. The aspect ratio is determined as an average value of the aspect ratios of at least five randomly selected recesses. When the uneven region is provided on both principal surfaces of the foil, the aspect ratio of the recesses in the both uneven regions may be the same or different.

The dimension of the short side Lmin may be 15 μm or more and 110 μm or less. The dimension of the short side Lmin may be 25 μm or more and 80 μm or less. The dimension of the short side Lmin is determined as an average value of the dimensions of the short side Lmin of at least five randomly selected recesses. When the uneven region is provided on both principal surfaces of the foil, the dimension of the short side Lmin of the recesses in the both uneven regions may be the same or different.

A shortest distance Dmin between the edges of the recesses closest to each other may be 1 time or more and 10 times or less the dimension of the short side Lmin. The shortest distance Dmin may be 15 μm or more and 300 μm or less. The shortest distance Dmin is determined as an average value of the shortest distances between the edges of at least five randomly selected pairs of the recesses closest to each other. Note that the “edge of the recess” refers to a point on the outline that defines the shape of the opening of the recess. When the uneven region is provided on both principal surfaces of the foil, the shortest distance between the edges of the recesses closest to each other in the both uneven regions may be the same or different.

A ratio Lmin/F of the dimension of the short side Lmin (μm) of the recesses to the thickness F (μm) of the separation portion is preferably less than 0.5. The Lmin/F ratio may be 0.1 or more.

A ratio Lmin/H of the dimension of the short side Lmin (μm) of the recesses to the depth H (μm) of the recesses is preferably 1 or more and 5 or less.

Next, a description will be given below of the case where the uneven region has a plurality of recesses extending in a line shape.

When viewed from the direction normal to the uneven region, the configuration of the individual recesses forming the plurality of recesses extending in a line shape is not particularly limited. The direction in which the plurality of recesses extend may each independently be parallel, perpendicular, or oblique, with respect to the direction from the first portion to the second portion (direction D12). The plurality of recesses may all extend substantially in one direction without intersecting with each other. Some of the recesses may extend in one direction while the rest of the recesses extend in another direction. The recesses may intersect with each other.

In the following, some of the parameters that define the plurality of recesses extending in a line shape will be described. The recesses satisfying any of the following conditions are particularly effective in enhancing the folding endurance and the tensile strength of the separation portion.

Each of the recesses extending in a line shape may be formed continuously in the direction in which the recess extends. For example, each of the recesses may be formed so as to cross the uneven region (or separation portion) from one end to the other end opposite thereto, and may be continuous without a break over a length L of, for example, 1 mm or more.

Each of the recesses extending in a line shape may be formed discontinuously (e.g., in a dashed-line shape) in the direction in which the recess extends. For example, each of the recesses may be formed intermittently such that the length L of each recess is less than 0.1 mm.

When the uneven region is provided on both principal surfaces of the foil, the recesses in both uneven regions may be continuous, and may be continuous only in one of the uneven regions.

The length L of each of the recesses extending in a line shape is, for example, 20 μm or more, may be 80 μm or more, and may be 300 μm or more. The length L of the recesses is determined as an average value of the lengths of at least five randomly selected recesses. When the uneven region is provided on both principal surfaces of the foil, the length L of the recesses in the both uneven regions may be the same or different.

The width W of the recesses in a line shape (the dimension perpendicular to the length direction of the recess) may be 15 μm or more and 110 μm or less. The width W of the recesses may be 25 μm or more and 80 μm or less. The width W of the recesses is determined as an average value of the widths of at least five randomly selected recesses. When the uneven region is provided on both principal surfaces of the foil, the width W of the recesses in the both uneven regions may be the same or different.

The ratio L/W of the length L of the recesses to the width W of the recesses may be 2 or more, and may be 40 or more.

The ratio W/F of the width W (μm) of the recesses to the thickness F (μm) of the separation portion (or foil) is preferably less than 0.5. The W/F ratio is preferably 0.1 or more.

In a typical case where all the plurality of recesses extend substantially in one direction without intersecting with each other (including the case where the recesses intersect with each other at an angle of −20° and 20° when the recesses are extended in the length direction), the plurality of recesses extend in a stripe pattern. In such a case, the shortest distance Dmin between the edges of the recesses closest to each other may be 10 μm or more and 300 μm or less. The shortest distance Dmin may be 30 μm or more and 200 μm or less. The shortest distance Dmin is determined as an average value of the shortest distances Dmin between the edges of at least five randomly selected pairs of the recesses closest to each other. Here, the shortest distance Dmin refers to a distance between lines adjacent to each other oriented in the same direction (the distance in the width direction of the recesses). When the uneven region is provided on both principal surfaces of the foil, the shortest distance Dmin between the edges of the recesses closest to each other in the both uneven regions may be the same or different.

The plurality of recesses may be in a mesh (or lattice) pattern. In such a case, the shortest distance Dmin between sides opposite to each other of a grid enclosed by the recesses may be 10 μm or more and 300 μm or less. The shortest distance Dmin may be 30 μm or more and 200 μm or less. The shortest distance Dmin is determined as an average value of the shortest distances Dmin between the edges of the recess in at least five randomly selected grids. When the uneven region is provided on both principal surfaces of the foil, the shortest distance Dmin in the both uneven regions may be the same or different.

In the capacitor element, the uneven region may be formed on a principal surface of the second portion, in addition to the separation portion. Furthermore, the uneven region may also be formed on a principal surface of the second portion and a principal surface of the portion extending from the second portion (a portion to be removed in a later process), in addition to the separation portion. Such a capacitor element can be more easily manufactured than one in which the uneven region is provided only on the separation portion (or on the separation portion and the first portion). Note that the uneven region may also be provided on the first portion of the capacitor element.

A description will be given below with reference to the drawings. The capacitor element and the electrolytic capacitor according to the present disclosure are not limited to the embodiments illustrated in the figures. The figures are schematic, and in the figures, the shapes or the features of the components do not necessarily reflect actual dimensions, and are not necessarily shown on the same scale.

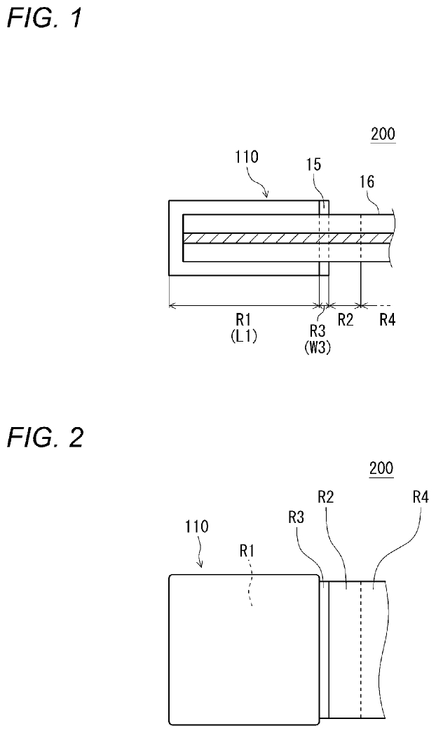

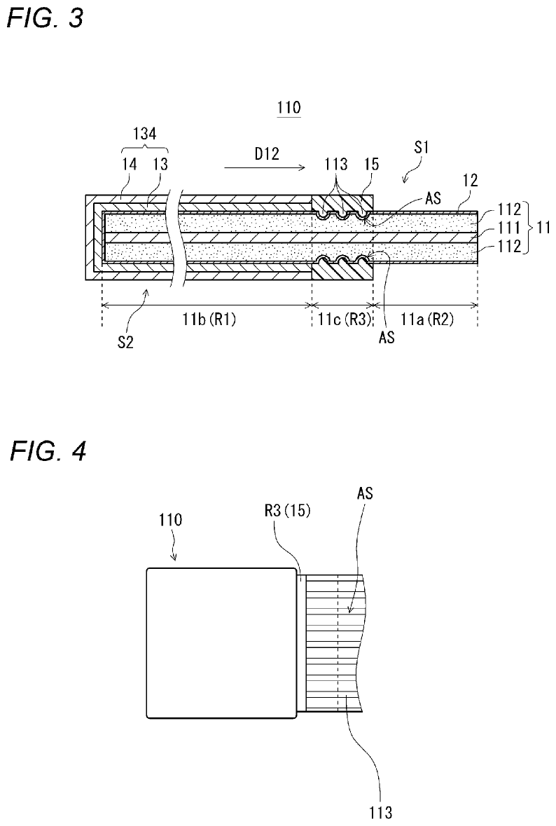

FIG. 1 is a schematic sectional view of a capacitor element 110. FIG. 2 is a schematic plan view of the capacitor element 110. FIG. 3 is a detailed schematic sectional view of the capacitor element 110, showing the details enlarged relative to FIG. 1.

The capacitor element 110 is formed using a metal foil (electrode foil) as a base, and substantially has a sheet-like shape. The capacitor element 110 includes an anode body 11 comprising an electrode foil as a base, a dielectric layer 12 covering at least part of the anode body 11, a solid electrolyte layer 13 covering at least part of the dielectric layer, and a cathode lead-out layer 14 covering at least part of the solid electrolyte layer 13. The solid electrolyte layer 13 and the cathode lead-out layer 14 constitute a cathode section 134. The cathode lead-out layer 14 is constituted by, for example, sequentially forming a carbon layer and a metal paste layer.

The anode body 11 has a first portion (R1) which is a cathode forming part 11b, a second portion (R2) including an anode lead-out part 11a, and a separation portion 11c (R3) between the first portion (R1) and the second portion (R2). The first portion (R1), the separation portion (R3), and the second portion (R2) each have porous parts 112 having principal surfaces and a core part 111 continuous with the porous parts 112. The separation portion (R3) has, on its principal surfaces, an uneven region AS having a plurality of recesses 113.

A width W3 of the uneven region AS in a direction D12 from the first portion (R1) toward the second portion (R2) is 10% or more of the length of the first portion (R1) in the direction D12. An electrically insulating resin 15 is attached on the surface of the separation portion (R3) so as to cover at least part of the uneven region AS.

In the capacitor element 110, the uneven region AS is formed at least on the surfaces of the porous parts 112 in the separation portion (R3). A plurality of recesses 113 extending in a line shape are formed in the uneven region AS. The recesses in a line shape are in a stripe pattern. The direction in which the recesses extend is preferably substantially parallel to the direction D12, but for the sake of convenience, the recesses are illustrated as being substantially orthogonal to the direction D12. Although not shown, the uneven region AS may be formed on the principal surfaces of the second portion (R2) and a portion 16 (R4) continued therefrom.

The following describes variations of the capacitor element. FIGS. 4 to 7 below show the cases where the uneven region AS is formed on the principal surfaces each of the separation portion (R3) and the second portion (R2). The recesses 113 formed on the separation portion (R3) are covered with the electrically insulating resin 15.

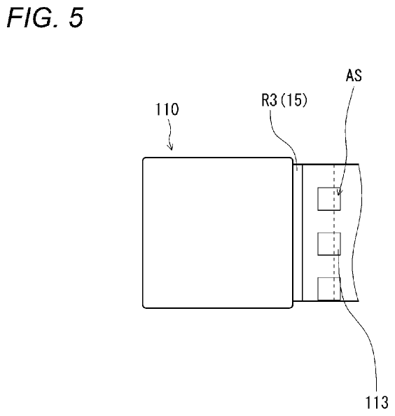

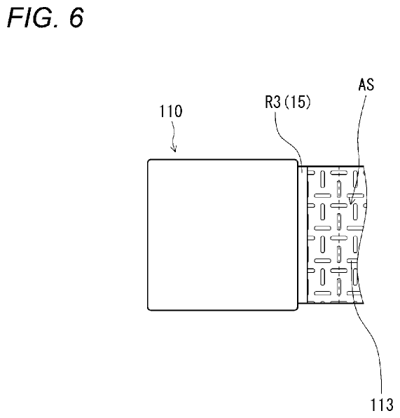

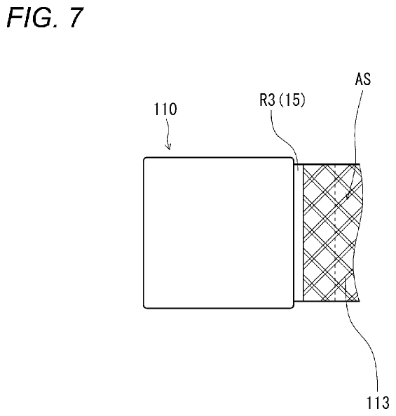

In the uneven region AS shown in FIG. 4, a plurality of the recesses 113 extending in a line shape are formed in a stripe pattern. The direction in which the recesses extend is substantially parallel to the direction D12. In the uneven region AS shown in FIG. 5, a plurality of the recesses 113 each of rectangular shape scattered in an island shape are provided. In the uneven region AS shown in FIG. 6, a plurality of the recesses 113 each of flat shape scattered in an island shape are provided. The flat-shaped recesses 113 are formed in alternating orientations at an angle of 90° to each other in the vertical direction and the horizontal direction of the plane of paper. In the uneven region AS shown in FIG. 7, a plurality of the recesses 113 extending in a line shape are arranged in a mesh (lattice) pattern. The recesses intersecting with each other all intersect with the direction D12 at an angle of approximately 60 to 70°.

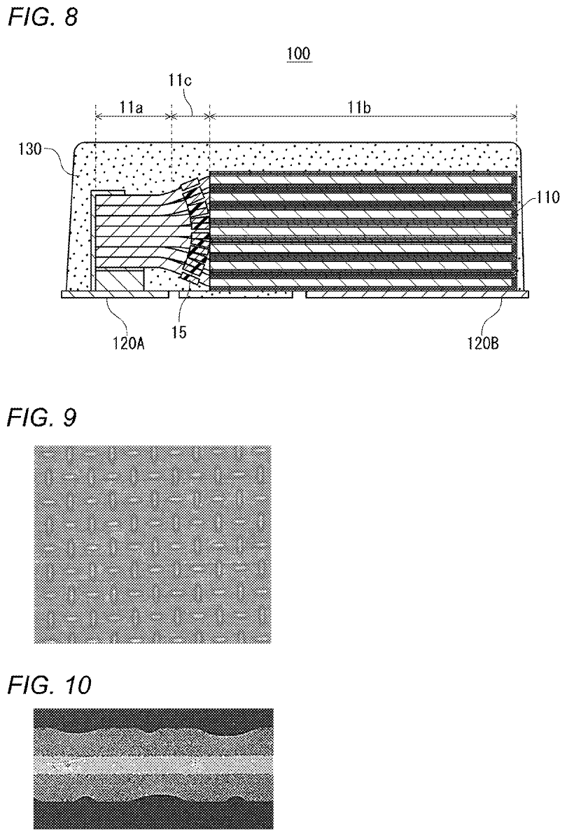

FIG. 8 is a schematic sectional view of an electrolytic capacitor according to the present embodiment. The electrolytic capacitor 100 includes a stack of a plurality of the capacitor elements 110, an anode lead terminal 120A connected to the anode lead-out parts 11a of the capacitor elements 110, a cathode lead terminal 120B connected to the cathode sections, and an encapsulation resin 130 that encapsulates the capacitor elements 110.

The solid electrolyte layer 13 preferably contains a conductive polymer. The conductive polymer may be, for example, a x-conjugated polymer. Examples of the conductive polymer include polypyrrole, polythiophene, polyfuran, and polyaniline. The conductive polymer may be used singly or in combination of two or more kinds, and may be a copolymer of two or more kinds of monomers. The weight-average molecular weight of the conductive polymer is, for example, 1,000 to 100,000.

In the present specification, polypyrrole, polythiophene, polyfuran, polyaniline, etc. each mean a polymer whose backbone is polypyrrole, polythiophene, polyfuran, polyaniline, etc. Therefore, polypyrrole, polythiophene, polyfuran, polyaniline, etc. can include their respective derivatives. For example, polythiophene includes poly(3,4-ethylenedioxythiophene), and the like.

The conductive polymer may be doped with a dopant. The solid electrolyte layer 13 may contain a dopant together with the conductive polymer. Examples of the dopant include polystyrene sulfonic acid.

A method for manufacturing an electrolytic capacitor includes, for example, a step of stacking capacitor elements as necessary, and electrically connecting lead terminals thereto, and a step of covering the capacitor elements and part of the lead terminals, with an outer package. An example thereof will be described below, but the method for manufacturing an electrolytic capacitor is not limited to the following example.

The capacitor element is formed, for example, by a method including the steps of:
(a-1) preparing a raw material foil (plain foil);
(a-2) roughening a surface of the raw material foil to form a porous part, thereby to form an electrode foil;
(a-3) forming a dielectric layer on the porous part;
(a-4) cutting out an anode body from the electrode foil having the dielectric layer; and
(a-5) forming a cathode section on a first portion of the anode body.

The raw material foil is a metal foil containing a valve metal, and has no porous part. By roughening a surface of the raw material foil, a porous part is formed, and an electrode foil is obtained. When the surface of the raw material foil is subjected an etching treatment (e.g., electrolytic etching), an etched foil is obtained.

The dielectric layer is formed by anodizing the electrode foil (etched foil). Anodization can be performed using a known chemical conversion treatment, etc. The chemical conversion treatment can be performed by immersing the electrode foil in a chemical conversion solution, and applying a voltage between the electrode foil serving as an anode and a counter electrode serving as a cathode. For the chemical conversion solution, for example, an aqueous phosphoric acid solution can be used. The dielectric layer can also be formed by other methods (e.g., atomic layer deposition (ALD) method).

The electrode foil having the dielectric layer usually has a wide, simple belt-like shape from which the anode body can be cut out. From such an electrode foil, an anode body is cut out by a processing, such as slitting and punching.

The anode body includes a first portion (R1), which is a cathode forming part, a second portion (R2) including an anode lead-out part, and a separation portion (R3) between the first portion (R1) and the second portion (R2).

Here, at any of the timings, an uneven region is formed at least in the separation portion (R3). For example, before cutting out an anode body, an uneven region may be formed in a predetermined place of a wide, simple belt-like shaped electrode foil. Alternatively, the uneven region may be formed in a predetermined place of the anode body after having been cut out.

The uneven region may be formed by pressing a jig having a plurality of protrusions against the electrode foil or the anode body. The uneven regions may be formed by pressing the electrode foil or the anode body between a pair of rollers having a plurality of protrusions. The uneven region may be formed by laser processing, blast processing, etching treatment, and the like.

Next, a cathode section is formed in the first portion of the anode body. Before the step of forming a cathode section, a step of providing an electrically insulating resin on the separation portion of the anode body may be included.

The insulating resin may be provided by a known method, such as coating or dispensing using various coaters or dispensers, immersion, and transfer (e.g., roller transfer). As the insulating resin, an insulating tape or a resist tape may be attached to the separation portion.

The step of forming a cathode section includes, for example, a step of forming a solid electrolyte layer so as to cover at least part of the dielectric layer, and a step of forming a cathode lead-out layer on the surface of the solid electrolyte layer.

The solid electrolyte layer may be formed, for example, using a processing solution containing a precursor of a conductive polymer, by polymerizing the precursor on the dielectric layer (so-called “in-situ polymerization”). The polymerization may be performed by chemical polymerization or by electrolytic polymerization. The solid electrolyte layer may be formed by allowing a dispersion or a solution containing a conductive polymer to adhere to the dielectric layer, followed by drying.

The step of forming a cathode lead-out layer includes, for example, a step of forming a carbon layer containing a conductive carbon, and a step of forming a metal paste layer containing a metal powder.

The carbon layer can be formed by immersing the anode body with the solid electrolyte layer formed thereon in a dispersion containing a conductive carbon, or by applying a paste containing a conductive carbon onto the surface of the solid electrolyte layer.

The metal paste layer can be formed by laminating a paste-like composition containing metal powder onto the surface of the carbon layer. The composition contains, for example, silver particles and a binder resin.

A capacitor element can be obtained through the process as above.

### (b) Lead Terminal Connection Step

A plurality of the capacitor elements are stacked as necessary, into a stack, and the respective anode lead-out parts are electrically connected to an anode lead terminal. To the cathode lead-out layers of the cathode sections, a cathode lead terminal is electrically connected. The anode lead-out parts and the anode lead terminal are electrically connected, for example, by welding. The cathode lead-out layers and the cathode lead terminal are electrically connected, for example, with a conductive adhesive.

### (c) Encapsulation Step

Subsequently, the capacitor elements and part of each lead terminal are encapsulated with an encapsulation resin. Encapsulation is performed using a molding technique, such as injection molding, insert molding, and compression molding. The encapsulation resin is a material of the outer package.

### (Supplementary Notes)

The above description of embodiments discloses the following techniques.

### (Technique 1)

A capacitor element, comprising:
a metal foil containing a valve metal, and having two principal surfaces, wherein
the metal foil has a first portion which is a cathode forming part, a second portion including an anode lead-out part, and a separation portion between the first portion and the second portion,
the first portion, the separation portion, and the second portion each have porous parts having the principal surfaces, and a core part continuous with the porous parts,
the metal foil has an uneven region having a plurality of recesses, on the principal surfaces, and
at least part of the separation portion overlaps with the uneven region.

### (Technique 2)

The capacitor element according to technique 1, wherein a width of the uneven region in a direction from the first portion toward the second portion is 10% or more of a length of the first portion in the direction from the first portion toward the second portion.

### (Technique 3)

The capacitor element according to technique 1 or 2, wherein
(A) a depth of the recesses is 5% or more and 80% or less of a distance from a surface of a non-recessed portion where no recess is formed, to the core part,
or
(B) a projected area ratio of the recesses in the uneven region is 3% or more and 65% or less.

### (Technique 4)

The capacitor element according to any one of techniques 1 to 3, wherein the uneven region has the plurality of recesses which are scattered in an island shape.

### (Technique 5)

The capacitor element according to technique 4, wherein a number density of the recesses is 4 recesses/mm² or more and 1200 recesses/mm² or less.

### (Technique 6)

The capacitor element according to technique 4 or 5, wherein a projected area per recess of the recesses is 150 μm² or more and 13,000 μm² or less.

### (Technique 7)

The capacitor element according to any one of techniques 4 to 6, wherein a ratio of a long side Lmax to a short side Lmin of a smallest rectangle surrounding each of the recesses is 1.0 to 2.5.

### (Technique 8)

The capacitor element according to technique 7, wherein a dimension of the short side Lmin is 15 μm or more and 110 μm or less.

### (Technique 9)

The capacitor element according to technique 7 or 8, wherein a shortest distance between edges of the recesses closest to each other is 1 time or more and 10 times or less the dimension of the short side.

### (Technique 10)

The capacitor element according to any one of techniques 1 to 3, wherein the uneven region has the plurality of recesses which extend in a line shape.

### (Technique 11)

The capacitor element according to technique 10, wherein a width of the recesses is 15 μm or more and 110 μm or less.

### (Technique 12)

The capacitor element according to technique 10 or 11, wherein a ratio of a length of the recesses to the width of the recesses is 40 or more.

### (Technique 13)

The capacitor element according to any one of techniques 10 to 12, wherein
the plurality of recesses are in a stripe pattern, and
a shortest distance between edges of the recesses closest to each other in a width direction of the recesses is 10 μm or more and 300 μm or less, or
the plurality of recesses are in a mesh pattern, and
a shortest distance between sides opposite to each other of a grid enclosed by the recesses is 10 μm or more and 300 μm or less.

### (Technique 14)

The capacitor element according to any one of techniques 10 to 13, wherein the plurality of recesses extend each independently in a direction parallel, perpendicular, or oblique to the direction from the first portion toward the second portion.

### (Technique 15)

The capacitor element according to any one of techniques 1 to 13, wherein the uneven region overlaps with at least part of the second portion, in addition to the separation portion.

### (Technique 16)

The capacitor element according to any one of techniques 1 to 14, wherein the uneven region overlaps with at least part of the first portion, in addition to the separation portion.

### (Technique 17)

An electrolytic capacitor, comprising:
the capacitor element according to any one of techniques 1 to 16 in which at least the porous parts of the first portion have a dielectric layer; and
a cathode section covering at least part of the dielectric layer, wherein
the cathode section contains a conductive polymer.

### EXAMPLES

The present disclosure will be more specifically described below with reference to Examples and Comparative Examples. The present disclosure, however, is not limited to the following Examples.

### Examples 1 to 15

### (Preparation of Electrode Foil)

A belt-like Al foil (plain foil, thickness F: 120 μm) as a raw material foil was subjected to an etching treatment. A porous part having sponge-like etched pits was thus formed on both principal surfaces of the raw material foil. The etched foil was further subject to a chemical conversion treatment at 49 V, to form a dielectric layer in the porous parts, thereby to obtain a chemical conversion foil. In this way, foils A1 to A15 were obtained.

### (Formation of Uneven Region)

A predetermined uneven region was formed in a region (R3) corresponding to the separation portion of the chemical conversion foil so as to satisfy the parameters shown in Table 1. The uneven region was formed by pressing the separation portion (R3) between rollers having predetermined protrusions. The line pressure (kg/cm) at this time is shown in Table 1.

The island-shaped recesses of A13 to A15 of Examples 13 to 15 are rectangular recesses arranged in a matrix pattern as illustrated in FIG. 5.

The ratio H/T of the depth H of the recesses on both surfaces to the thickness T of the porous parts are shown as a percentage (%) in Table 1.

### Comparative Example 1

A foil B1 was prepared in the same manner as in Example 1, except that no uneven region was formed in the region (R3) corresponding to the separation portion of the chemical conversion foil.

### [Evaluation 1]

The obtained foils of Examples and Comparative Examples were evaluated as follows.

### [Measurement of Folding Endurance]

The chemical conversion foils were measured for the folding endurance in the direction D12. The measurement was performed in accordance with the test method of electrode foil for aluminum electrolytic capacitors specified in the Japan Electronic Machinery Industry Standard (EIAJ RC-2364A). The size of a test specimen was 100 mm in the length direction and 10 mm in the width direction. The curvature radius of the bending section was set to 3.5 mm (R3.5). The folding endurance was expressed as a relative value, when the folding endurance of the foil B1 of Comparative Example 1 was taken as 100. The higher the numerical value is, the better. The results are shown in Table 1.

TABLE 1

| | | | | | | | folding |
|---|---|---|---|---|---|---|---|
| | | | | | | | endurance |
| | | W or | | line | | | (R3.5) |
| | uneven | Lmin | Dmin | pressure | H | H/T | relative |
| foil | region | (μm) | (μm) | (kg/cm) | (μm) | (%) | value |
| A1 | stripe | 20 | 140 | 50 | 7 | 17 | 114 |
| A2 | orthogonal | | | 100 | 9 | 22 | 113 |
| A3 | to D12 | | | 150 | 9 | 22 | 168 |
| A4 | stripe | 40 | 200 | 50 | 9 | 22 | 154 |
| A5 | orthogonal | | | 100 | 11 | 27 | 137 |
| A6 | to D12 | | | 150 | 14 | 34 | 175 |
| A7 | stripe | 20 | 140 | 50 | 6 | 14 | 137 |
| A8 | parallel | | | 100 | 7 | 17 | 136 |
| A9 | to D12 | | | 150 | 9 | 22 | 140 |
| A10 | stripe | 40 | 200 | 50 | 6 | 14 | 126 |
| A11 | parallel | | | 100 | 9 | 22 | 128 |
| A12 | to D12 | | | 150 | 12 | 29 | 150 |
| A13 | island-shape | 100 | 530 | 15 | 13 | 31 | 139 |
| A14 | (FIG. 5) | | | 30 | 17 | 41 | 133 |
| A15 | | | | 50 | 30 | 72 | 111 |
| B1 | — | — | — | — | — | — | 100 |

The foils A1 to A15 all exhibited higher folding endurance than the foil B1.

### Examples 16 to 30

The chemical conversion voltage for the etched foil was changed as shown in Table 2, to obtain chemical conversion foils. Furthermore, predetermined uneven regions were formed so as to satisfy the parameters shown in Table 2. The line pressure (kg/cm) and the H/T ratio at this time are shown in Table 2.

### Comparative Examples 2 to 6

Foils B2, B3, B4, B5, and B6 were prepared in the same manner as in Examples 16, 19, 22, 25, and 28, respectively, except that no uneven region was formed in the region (R3) corresponding to the separation portion of the chemical conversion foil.

### [Evaluation 2]

### [Measurement of Folding Endurance]

The foils of Examples and Comparative Examples were evaluated in a similar manner to the above. The results are shown in Table 2.

The folding endurances in Examples 16 to 18 are expressed as a relative value when the folding endurance of the foil B2 in Comparative Example 2 is taken as 100.

The folding endurances in Examples 19 to 21 are expressed as a relative value when the folding endurance of the foil B3 in Comparative Example 3 is taken as 100.

The folding endurances in Examples 22 to 24 are expressed as a relative value when the folding endurance of the foil B4 in Comparative Example 4 is taken as 100.

The folding endurances in Examples 25 to 27 are expressed as a relative value when the folding endurance of the foil B5 in Comparative Example 5 is taken as 100.

The folding endurances in Examples 28 to 30 are expressed as a relative value when the folding endurance of the foil B6 in Comparative Example 6 is taken as 100.

The higher the numerical value is, the better. The results are shown in Table 2.

TABLE 2

| | | | | | | | | folding |
|---|---|---|---|---|---|---|---|---|
| | chemical | | | | | | | endurance |
| | conversion | | W or | | line | | | (R3.5) |
| | voltage | | Lmin | Dmin | pressure | H | H/T | relative |
| foil | (V) | uneven region | (μm) | (μm) | (kg/cm) | (μm) | (%) | value |
| A16 | 16 | stripe | 40 | 200 | 50 | 13 | 27 | 137 |
| A17 | | orthogonal to D12 | | | 100 | 15 | 32 | 178 |
| A18 | | | | | 150 | 13 | 27 | 169 |
| B2 | 16 | — | — | — | — | — | — | 100 |
| A19 | 32 | stripe | 40 | 200 | 50 | 11 | 23 | 114 |
| A20 | | orthogonal to D12 | | | 100 | 10 | 21 | 124 |
| A21 | | | | | 150 | 15 | 32 | 106 |
| B3 | 32 | — | — | — | — | — | — | 100 |
| A22 | 40 | stripe | 40 | 200 | 100 | 9 | 23 | 140 |
| A23 | | orthogonal to D12 | | | 125 | 10 | 25 | 115 |
| A24 | | | | | 150 | 13 | 33 | 132 |
| B4 | 40 | — | — | — | — | — | — | 100 |
| A25 | 50 | stripe | 40 | 200 | 125 | 12 | 30 | 149 |
| A26 | | orthogonal to D12 | | | 150 | 13 | 33 | 123 |
| A27 | | | | | 170 | 13 | 33 | 156 |
| B5 | 50 | — | — | — | — | — | — | 100 |
| A28 | 70 | stripe | 40 | 200 | 125 | 8 | 17 | 159 |
| A29 | | orthogonal to D12 | | | 150 | 10 | 21 | 142 |
| A30 | | | | | 170 | 8 | 17 | 157 |
| B6 | 70 | — | — | — | — | — | — | 100 |

The foils A16 to A30 exhibited higher folding endurance than the foils B2 to B6.

### Examples 31 to 33

The chemical conversion voltage for the etched foil was changed to 5 V, and a predetermined uneven region was formed so as to satisfy the parameters shown in Table 3. The line pressure (kg/cm) and the H/T ratio when forming the uneven region are shown in Table 3.

The island-shaped recesses in A31 to A33 of Examples 31 to 33 were flat recesses that were arranged in a matrix pattern as illustrated in FIG. 6 and formed in alternating orientations at 90° to each other. A top-view SEM image of the uneven region is shown in FIG. 9, and a sectional-view SEM image of the uneven region is shown in FIG. 10.

### Comparative Example 7

A foil B7 was prepared in the same manner as in Example 31, except that no uneven region was formed in the region (R3) corresponding to the separation portion of the chemical conversion foil.

### [Evaluation 3]

### [Measurement of Tensile Strength]

The foils of Examples and Comparative Examples were measured for the tensile strength in the D12 direction. The measurement was performed in accordance with the test method of electrode foil for aluminum electrolytic capacitors specified in the Japan Electronic Machinery Industry Standard (EIAJ RC-2364A). The size of a test specimen was 65 mm in the length direction and 10 mm in the width direction. The results are shown in Table 3.

### [Measurement of Folding Endurance]

The foils of Examples and Comparative Examples were evaluated in a similar manner to the above. The results are shown in Table 3.

The tensile strength and the folding endurance in Examples 31 to 33 are expressed as relative values, when the tensile strength and the folding endurance of the foil B7 in Comparative Example 7 are taken as 100.

TABLE 3

| | | | | | | | | | folding |
|---|---|---|---|---|---|---|---|---|---|
| | chemical | | | | | | | tensile | endurance |
| | conversion | | | | line | | | strength | (R3.5) |
| | voltage | uneven | Lmin | Dmin | pressure | H | H/T | relative | relative |
| foil | (V) | region | (μm) | (um) | (kg/cm) | (μm) | (%) | value | value |
| A31 | 5 | island- | 60 | 340 | 30 | 9 | 16 | 113 | 114 |
| A32 | | shape | | | 41 | 16 | 28 | 117 | 107 |
| A33 | | (FIG. 6) | | | 53 | 22 | 38 | 112 | 135 |
| B7 | 5 | — | — | — | — | — | — | 100 | 100 |

The foils A31 to A33 all exhibited higher tensile strength and folding endurance than the foil B7.

The capacitor element according to the present disclosure is suitable for use in an electrolytic capacitor for which high reliability is required.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE NUMERALS

100 electrolytic capacitor
   110 capacitor element
      11 anode body
         111 core part
         112 porous part
      134 cathode section
         12 dielectric layer
         13 solid electrolyte layer
         14 cathode lead-out layer
      15 insulating resin
   120A anode lead terminal
   120B cathode lead terminal
   130 encapsulation resin
   134 cathode section

What is claimed is:

1. A capacitor element, comprising:
a metal foil containing a valve metal, and having two principal surfaces, wherein
the metal foil has a first portion which is a cathode forming part, a second portion including an anode lead-out part, and a separation portion between the first portion and the second portion,
the first portion, the separation portion, and the second portion each have porous parts having the principal surfaces, and a core part continuous with the porous parts,
the metal foil has an uneven region having a plurality of recesses, on the principal surfaces, and
at least part of the separation portion overlaps with the uneven region.

2. The capacitor element according to claim 1, wherein a width of the uneven region in a direction from the first portion toward the second portion is 10% or more of a length of the first portion in the direction from the first portion toward the second portion.

3. The capacitor element according to claim 1, wherein
(A) a depth of the recesses is 5% or more and 80% or less of a distance from a surface of a non-recessed portion where no recess is formed, to the core part,
or
(B) a projected area ratio of the recesses in the uneven region is 3% or more and 65% or less.

4. The capacitor element according to claim 1, wherein the uneven region has the plurality of recesses which are scattered in an island shape.

5. The capacitor element according to claim 4, wherein a number density of the recesses is 4 recesses/mm² or more and 1200 recesses/mm² or less.

6. The capacitor element according to claim 4, wherein a projected area per recess of the recesses is 150 μm² or more and 13,000 μm² or less.

7. The capacitor element according to claim 4, wherein a ratio of a long side Lmax to a short side Lmin of a smallest rectangle surrounding each of the recesses is 1.0 to 2.5.

8. The capacitor element according to claim 7, wherein a dimension of the short side Lmin is 15 μm or more and 110 μm or less.

9. The capacitor element according to claim 7, wherein a shortest distance between edges of the recesses closest to each other is 1 time or more and 10 times or less the dimension of the short side.

10. The capacitor element according to claim 1, wherein the uneven region has the plurality of recesses which extend in a line shape.

11. The capacitor element according to claim 10, wherein a width of the recesses is 15 μm or more and 110 μm or less.

12. The capacitor element according to claim 10, wherein a ratio of a length of the recesses to the width of the recesses is 40 or more.

13. The capacitor element according to claim 10, wherein
the plurality of recesses are in a stripe pattern, and
a shortest distance between edges of the recesses closest to each other in a width direction of the recesses is 10 μm or more and 300 μm or less, or
the plurality of recesses are in a mesh pattern, and
a shortest distance between sides opposite to each other of a grid enclosed by the recesses is 10 μm or more and 300 μm or less.

14. The capacitor element according to claim 10, wherein the plurality of recesses extend each independently in a direction parallel, perpendicular, or oblique to the direction from the first portion toward the second portion.

15. The capacitor element according to claim 1, wherein the uneven region overlaps with at least part of the second portion, in addition to the separation portion.

16. An electrolytic capacitor, comprising:
the capacitor element according to claim 1 in which at least the porous parts of the first portion have a dielectric layer; and
a cathode section covering at least part of the dielectric layer, wherein
the cathode section contains a conductive polymer.
